(19) United States
(12) Patent Application Publication
(10) Pub. No.: US 2026/0246654 A1
(43) Pub. Date: Aug. 20, 2026

(54) SYSTEMS FOR AND METHODS FOR DECENTRALIZED AIR-TO-AIR COMMUNICATION

(71) Applicant: ASTRONAUTICS CORPORATION OF AMERICA, Oak Creek, WI (US)

(72) Inventors: Davis CHAPPINS, Oak Creek, WI (US); David JONES, Oak Creek, WI (US)

(21) Appl. No.: 18/869,900

(22) PCT Filed: Jun. 2, 2023
(86) PCT No.: PCT/US2023/067868

§ 371 Date: Nov. 27, 2024

Related U.S. Application Data
(60) Provisional application No. 63/365,719, filed on Jun. 2, 2022.

(51) Int. Cl. H04L 9/00; H04B 7/185; H04L 9/32

(52) U.S. Cl. CPC H04L 9/50; H04B 7/18504; H04L 9/3297

(57) ABSTRACT

Disclosed are systems, methods, and media for a communication system for an aerospace system including a communications module that is configured to communicatively couple the aerospace system to an aircraft communication network using a blockchain. The communication system further includes a processor that is configured to communicate aircraft data having a unique hash ID between the aerospace system and one or more subsequent aerospace systems in the aircraft communication network via the communications module. The processor can be configured to access or receive the aircraft data and validate the unique hash ID of the aircraft data using the blockchain. Upon validation of the unique hash ID, the process can be configured to install the aircraft data on the aerospace system and broadcasting a copy of the aircraft data to the one or more subsequent aerospace systems.

### CROSS-REFERENCE TO RELATED APPLICATIONS

This patent application claims the benefit of U.S. Provisional Patent Application 63/365,719, filed on Jun. 2, 2022, the entire contents of which is hereby incorporated by reference, for any and all purposes.

### STATEMENT REGARDING FEDERALLY SPONSORED RESEARCH

N/A

### BACKGROUND

The present disclosure relates generally to systems and methods for communicating signals between aircraft as well as between aircraft and ground systems. More specifically, the present disclosure relates to systems and methods for providing decentralized communication between aircraft, for example, using blockchain technologies.

### SUMMARY

The present disclosure provides systems, methods, and media for securely communicating aircraft data across an aerospace communication network within the careful constraints that are unique to aircraft. In accordance with one non-limiting example, a communication system may be used to communicate with a blockchain to securely access and validate aircraft data using blockchain technology before installing the aircraft data onto an aerospace system and broadcasting a copy of the aircraft data to a subsequent aerospace system. Accordingly, the communication of aircraft data in an aerospace network can be simplified and the reliance upon cost-intensive barriers to entry associated with conventional centralized communication systems can be eliminated. Further, the security of software data can be enhanced, thus leading to increased safety of aerospace systems and all those associated with aerospace systems, such as pilots, crew members, passengers, ground control personnel, maintenance personnel, etc.

In accordance with one aspect of the disclosure, a communication for an aerospace system is provided including a communications module configured to communicatively couple the aerospace system to an aircraft communication network using a blockchain and a processor configured to communicate aircraft data having a unique hash ID between the aerospace system and one or more subsequent aerospace systems in the aircraft communication network. The processor is further configured to communicate the aircraft data by accessing or receiving the aircraft data, validating the unique hash ID of the aircraft data using the blockchain, and only upon validation of the unique hash ID, installing the aircraft data on the aerospace system and broadcasting a copy of the aircraft data to the one or more subsequent aerospace systems.

In accordance with another aspect of the disclosure, a method is provided for communicating aircraft data between an aerospace system and one or more subsequent aerospace systems. The method includes identifying the aircraft data having a unique hash ID and coupling a communications system to the aerospace system to receive the aircraft data. The method further includes validating the unique hash ID for the aircraft data using a blockchain, and upon validation of the unique hash ID, installing the aircraft data on the aerospace system and broadcasting a copy of the aircraft data to the one or more subsequent aerospace systems using the communications system.

In accordance with yet another aspect of the disclosure, a non-transitory computer-readable medium is provided containing software applications that, when executed, cause a communications system to perform operations. The operations include accessing or receiving aircraft data to provide a copy of the aircraft data to an aerospace system, validating a unique hash ID for the aircraft data using a blockchain, and upon validation of the unique hash ID, installing the aircraft data on the aerospace system and broadcasting the copy of the aircraft data to one or more subsequent aerospace systems.

The foregoing and other aspects and advantages of the present disclosure will appear from the following description. In the description, reference is made to the accompanying drawings that form a part hereof, and in which there is shown by way of illustration one or more embodiment. These embodiments do not necessarily represent the full scope of the invention, however, and reference is therefore made to the claims and herein for interpreting the scope of the invention. Like reference numerals will be used to refer to like parts from Figure to Figure in the following description.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1A is an example of typical aircraft messages broadcast during different phases of flight in accordance with aspects of the present disclosure.

FIG. 1B is another example of typical aircraft messages broadcast during different phases of flight in accordance with aspects of the present disclosure.

FIG. 1C is yet another example of typical aircraft messages broadcast during different phases of flight in accordance with aspects of the present disclosure.

FIG. 2 is a world map of avionic telecommunication jurisdictions using centralized communication systems.

FIG. 3 is an example of a decentralized aerospace communication network in accordance with aspects of the present disclosure.

FIG. 4A is an example of broadcasting aircraft data between aircraft systems in a decentralized aerospace communication network in accordance with aspects of the present disclosure.

FIG. 4B is another example of broadcasting aircraft data between aircraft systems in a decentralized aerospace communication network in accordance with aspects of the present disclosure.

FIG. 5 is yet another example of broadcasting aircraft data between aircraft systems in a decentralized aerospace communication network in accordance with aspects of the present disclosure.

FIG. 6 is a block diagram of an aircraft system in a decentralized aerospace communication network in accordance with aspects of the present disclosure.

FIG. 7 is a block diagram of a recording module used in the aircraft system of FIG. 6 in accordance with aspects of the present disclosure.

FIG. 8 is an example schematic of a blockchain used to track and verify aircraft data across an aerospace communication network in accordance with aspects of the present disclosure.

FIG. 9 is a flowchart of non-limiting example steps for a method of communicating aircraft data across an aerospace communication network using a blockchain in accordance with aspects of the present disclosure.

FIG. 10 is a flowchart of non-limiting example steps for a method of receiving aircraft data over a decentralized aerospace communication network in accordance with aspects of the present disclosure.

FIG. 11 is a flowchart of non-limiting example steps for a method of updating aircraft data based on aircraft status in accordance with aspects of the present disclosure.

### DESCRIPTION

Before any aspects of the disclosure are explained in detail, it is to be understood that the present disclosure is not limited in its application to the details of construction and the arrangement of components set forth in the following description or illustrated in the following drawings. The present disclosure is readily extended to other aspects and implementations and may be practiced or carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

As used herein in the context of computer implementation, unless otherwise specified or limited, the terms “component,” “system,” “module,” “controller,” “framework,” and the like are intended to encompass part or all of computer-related systems that include hardware, software, a combination of hardware and software, or software in execution. For example, a component may be, but is not limited to being, a processor device, a process being executed (or executable) by a processor device, an object, an executable, a thread of execution, a computer program, or a computer. By way of illustration, both an application running on a computer and the computer can be a component. One or more components (or system, module, and so on) may reside within a process or thread of execution, may be localized on one computer, may be distributed between two or more computers or other processor devices, or may be included within another component (or system, module, and so on).

In the methods described herein, the steps can be carried out in any order without departing from the principles of the disclosure, except when a temporal or operational sequence is explicitly recited. Recitation in a claim to the effect that first a step is performed, and then several other steps are subsequently performed, shall be taken to mean that the first step is performed before any of the other steps, but the other steps can be performed in any suitable sequence, unless a sequence is further recited within the other steps. For example, claim elements that recite “Step A, Step B, Step C, Step D, and Step E” shall be construed to mean step A is carried out first, step E is carried out last, and steps B, C, and D can be carried out in any sequence between steps And E, and that the sequence still falls within the literal scope of the claimed process. A given step or sub-set of steps can also be repeated.

Furthermore, specified steps can be carried out concurrently unless explicit claim language recites that they be carried out separately. For example, a claimed step of doing X and a claimed step of doing Y can be conducted simultaneously within a single operation, and the resulting process will fall within the literal scope of the claimed process.

The term “substantially” as used herein refers to a majority of, or mostly, as in at least about 50%, at least about 60%, at least about 70%, at least about 80%, at least about 90%, at least about 95%, at least about 96%, at least about 97%, at least about 98%, at least about 99%, at least about 99.5%, at least about 99.9%, at least about 99.99%, or at least about 99.999% or more.

The following discussion is presented to enable a person skilled in the art to make and use aspects of the disclosure. Various modifications to the illustrated configurations or processes will be readily apparent to those skilled in the art, and the generic principles herein can be applied to other aspects and applications within the scope of the present disclosure and the understanding of one of skill based thereon. Thus, the present disclosure is not intended to be limited to particular embodiments or aspects shown, but is to be accorded the widest scope consistent with the principles and features disclosed herein. The following detailed description is to be read with reference to the figures, in which like components or elements fin different figures have like reference numerals. The figures, which are not necessarily to scale, depict selected aspects and configurations or processes and are not intended to limit the scope of the disclosure. Skilled artisans will recognize the examples provided herein have many useful alternatives and fall within the scope of the disclosure.

In accordance with aspects of the present disclosure, mechanisms (which can, for example, include systems, methods, and media) for using a decentralized air-to-air (A2A) communications network configured, for example, as a blockchain framework and within the careful constraints that are unique to aircraft are provided.

However, conventional aerospace systems typically rely upon centralized, point-to point communication protocols that involve sending data via a transmitter and receiving data via a receiver. Centralized communication protocols are used both over land, when data is transmitted between aircraft and ground systems via very high frequency (VHF) or Airband signals, and over open ocean, when data is transmitted between air and ground systems via satellite communications. Since these centralized protocols often rely upon extensive infrastructure to achieve their function, the barrier to entry for avionic communication is high, and a few, long-established telecommunication providers who own the majority of the avionic communication hardware and infrastructure dominate the use and pricing thereof. In addition to the inherently high barriers to entry, centralized communication protocols are limited in relation to broadcasting range, amount of data that can be communicated at any time, and security.

For example, Automatic Dependent Surveillance—Broadcast (ADSB) is a standard for Traffic Collision Avoidance Systems (TCAS) and position reporting for commercial and private aircraft. Aircraft positions, among other aircraft data, are received by ground and air traffic control (ATC) systems to provide aircraft monitoring, worldwide. However, conventional ADSB methods lack sufficient encryption methods to differentiate validated aircraft data from malicious signals that are generated outside of an aerospace network. As a result, conventional aerospace communication networks are vulnerable to fake or falsified aircraft data being broadcast alongside validated aircraft data, and the nature of such centralized communication may cause networks to become convoluted or incapable of differentiating between real data and “fake” data. This in turn may result in devastating effects on avionic systems on a global scale, or even cause air traffic to come to a complete halt.

Therefore, there is a need for aerospace communication systems and methods which provide enhanced security and cyber protection for messages or flight data that are broadcast between members of an aircraft communication network. Further, there is a need for decentralized communication systems that can be implemented across new and legacy aerospace systems to provide an alternative to centralized communication protocols with high barriers to entry as discussed above. In addition, there is a need for aerospace communication systems that maintain a detailed transaction history of communication across an aerospace communication network to further protect aircraft data from being compromised.

Generally, the present disclosure provides systems, methods, and media for using a secure communications system that can advantageously access, validate, and broadcast aircraft data that travels through an aerospace communications network. In particular, aspects of the present disclosure provide systems, methods and media for recording a transactional history for aircraft data across a decentralized aerospace communication network.

In some non-limiting examples, an aerospace communication system may be configured as a set of software instructions on a computing device onboard an aircraft or in a ground facility as part of an aerospace system. In one non-limiting example, the aerospace communication system can be coupled to a blockchain to securely access and validate aircraft data. Further, a blockchain may be used across an aerospace communication network to encrypt aircraft data and record a decentralized transactional history associated with the aircraft data. For example, a blockchain can be used to store a digital signature or unique hash ID associated with aircraft data, and the unique hash ID can be updated each time the aircraft data is accessed, archived, modified, or broadcast. In some aspects, the blockchain can be used to facilitate aircraft-to-aircraft (A2A) communication without the use of a centralized transmitter or receiver, thereby increasing the availability of real-time data to all aircraft in an aerospace communication network. Correspondingly, the aerospace communication system can use the blockchain to validate the chain of custody and data of the aircraft data to confirm that the aircraft data is real data that has not been the target of tampering. To that end, the aerospace communication system can be used to ensure that only verified aircraft data are installed on aerospace systems, thus decreasing the risk that falsified data or malware will interfere with aerospace systems. Accordingly, an advantage of the present disclosure is that the use of a secure aerospace communication system in accordance with some aspects can enhance the security of aircraft data, and, as a result, increase safety of aerospace systems and all those associated with aerospace systems, such as pilots, crew members, passengers, ground control personnel, maintenance personnel, etc.

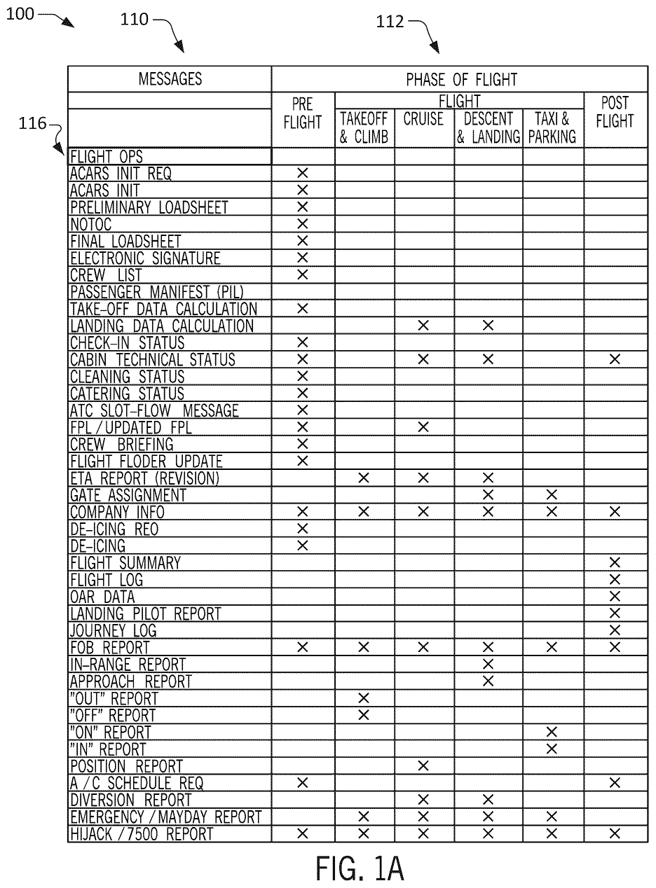

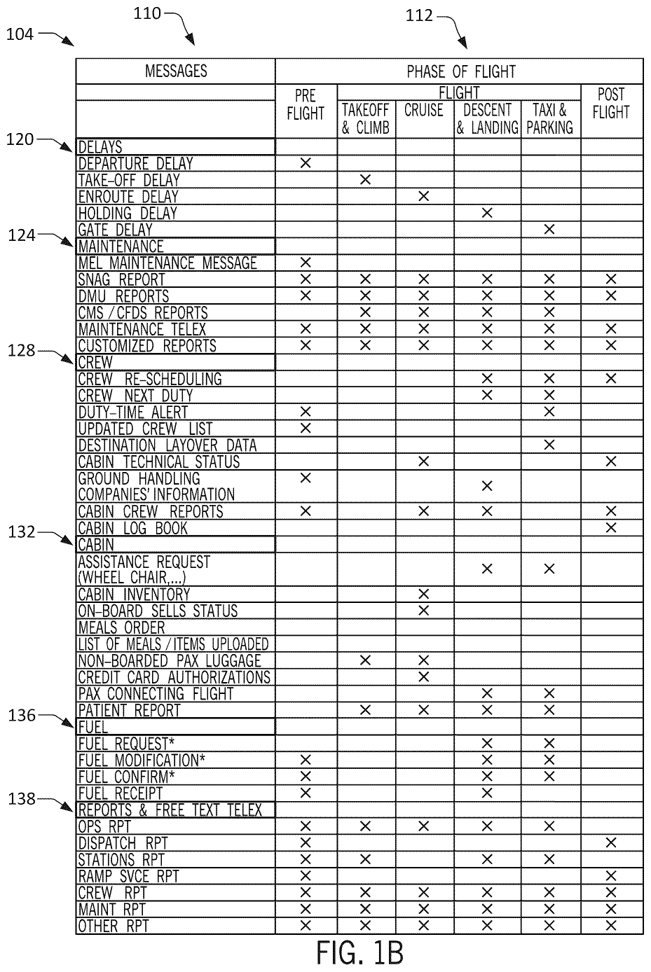

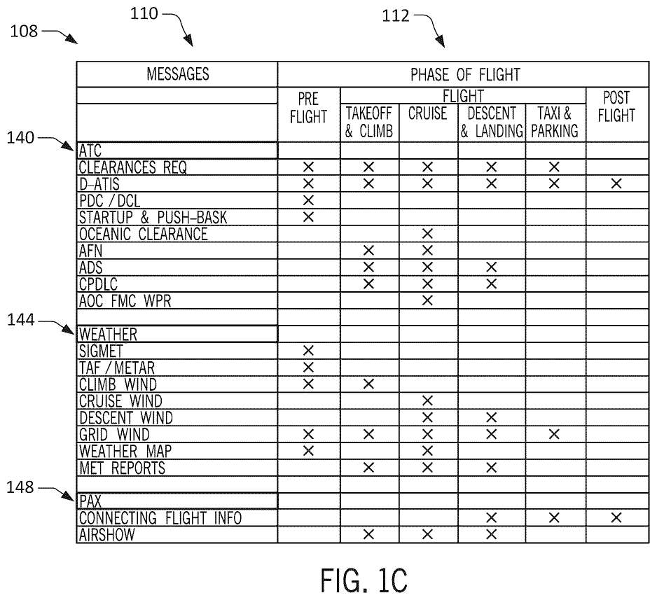

FIGS. 1A-1C illustrate examples of typical aircraft data that is communicated across an aerospace communication network. As discussed above, aircraft messages or data can be communicated across an aerospace communication network using a variety of different methods. For example, different messages related to status of an aircraft are generally sent and received by commercial aircraft, civil aircraft, and ground systems using the Aircraft Communications Addressing and Reporting System (ACARS). Aircraft data broadcast using ACARS typically use conventional, centralized communication systems, such as networks of antennas or ground stations that are owned and operated by telecommunication providers. In some aspects, an aerospace system (e.g., an aerospace system on an aircraft) may communicate aircraft data at different times based on a current phase of flight. FIGS. 1A-1C illustrate tables 100, 104, 108, categorizing aircraft data 110 in relation to the per phase of flight 112. Referring to table 100 depicted in FIG. 1A, aircraft data can include, but is not limited to, flight operation data 116. Referring to table 104 depicted in FIG. 1B, aircraft data can also include, but is not limited to, delay data 120, maintenance data 124, crew data 128, cabin data 132, fuel data 136, and/or reports and fee text telex data 138. Referring to table 108 depicted in FIG. 1C, aircraft data can also include, but is not limited to, ATC data 140, weather data 144, and passenger (Pax) data 148. It will be understood that aircraft data may include additional or fewer types of data other than those illustrated in FIGS. 1A-1C, such as positional data (e.g., altitude, latitude/longitude coordinates, rate of climb/descent, etc.), wind data, windshear data, engine related data, environmental data, airline operational data, or ADSB data (e.g., squawk code). Accordingly, aerospace systems can broadcast a variety of aircraft data at any time to report and perform vital functions pre-, during, and post-flight.

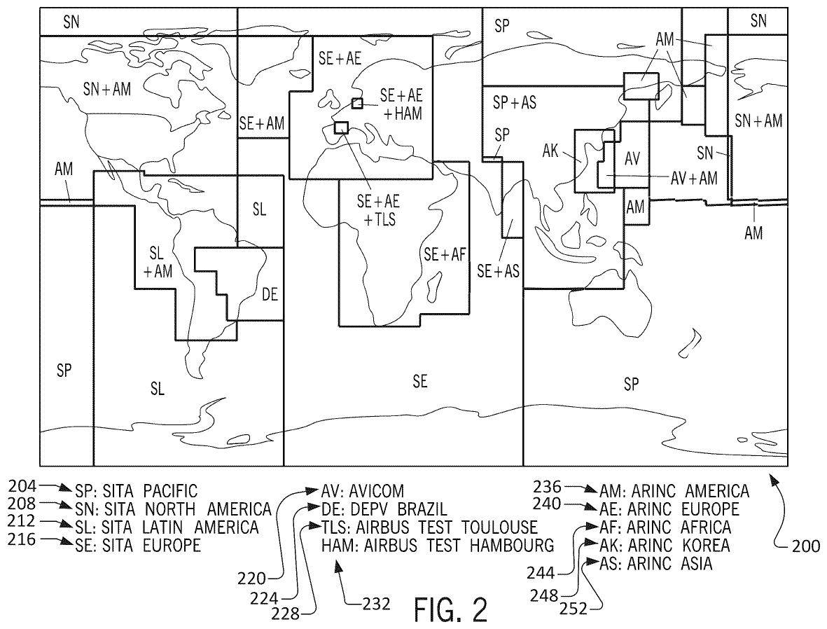

As discussed above, conventional aerospace communication systems are governed by a few telecommunication providers, worldwide. As such, there is a lack of competition in the avionic telecommunication market which can lead to higher prices and restrictions for airlines which, out of necessity, use such aerospace communication systems. Further, conventional aerospace communication systems are generally centralized systems which rely upon cost-intensive ground stations to broadcast aircraft data. Since such systems are typically ground-based, the globe is split into distinct telecommunication jurisdictions. FIG. 2 is a labeled world map 200 illustrating different telecommunication provider coverage areas. Specifically, the world map 200 can be divided into 12 jurisdictions: SITA Pacific (SP) 204, SITA North America (SN) 208, SITA Latin America (SL) 212, SITA Europe (SE) 216, AVICOM (AV) 220, DEPV Brazil (DE) 224, Airbus Test Toulouse (TLS) 228, Airbus Test Hambourg (HAM) 232, ARINC America (AM) 236, ARINC Europe (AE) 240, ARINC Africa (AF) 244, ARINC Korea (AK) 248, and ARINC Asia (AS) 252. In some aspects, two or more of the jurisdictions overlap in certain geographical areas.

Thus, conventional centralized aerospace communication systems that are ground-based result in geographically-limited telecommunication jurisdictions. Put another way, conventional aerospace communication systems rely upon a few centralized transmitters to broadcast aircraft data to aircraft (i.e., receivers), worldwide. As a result, situational data recorded by aircraft during flight, e.g., real-time weather data, is first broadcast back to the central ground-based transmitters before being re-broadcast to other aircraft in the network. In addition to the security and cost disadvantages discussed above, relying upon a central communication system may result in limited efficiency due to the delay of real-time data being broadcast across the network.

Referring now to the non-limiting example illustrated in FIG. 2, a communication network (e.g., the communication network 300) can be simplified and safeguarded against malicious interference using a decentralized communication system in accordance with the present disclosure, which may be connected to or in communication with a blockchain. As will be described in greater detail below, a decentralized communication system can be a communication system that utilizes a blockchain or blockchain technology to securely access, validate, and broadcast aircraft data. The decentralized communication system can facilitate communication between aerospace systems (e.g., aircraft systems and/or ground systems) in an aerospace communication network via a blockchain. In this way, aerospace systems can be in direct communication with each other without the need for an intermediary, centralized broadcasting system. Advantageously, a blockchain can be used to archive, access, and validate aircraft data to reduce the time needed to communicate relevant information to nearby aircraft by way of communication via the blockchain. Further, aircraft can be archived in a particular location in the communication network (i.e., on any aerospace system) after being accessed by any member of the communication network, and aircraft data can be validated using the blockchain in order to ensure that the aircraft data does not become compromised. Accordingly, aircraft data can include an additional layer of security by using a decentralized communication system with a blockchain to archive and validate the software.

For example, an aerospace communication network 300 can include one or more aerospace systems (e.g., a first aerospace system 304, a second aerospace system 308, a third aerospace system 312), a blockchain 316, and a ground system 320. The aerospace systems 304, 308, 312 can be in communication with the blockchain 316, and the ground system 320 can also be in communication with the blockchain 316. As will be discussed below in greater detail, any member in the network 300 can provide (e.g., send, transport through physical or digital means, transmit, etc.) aircraft data to one or more of the other members. The blockchain 316 can be updated accordingly to record information related to the aircraft data that may be communicated across the network 300, and the aerospace systems 304, 308, 312 can be configured to access the aircraft data that is received by validating the aircraft data using the blockchain 316. After the one or more aerospace systems 304, 308, 312 validate the aircraft data using the blockchain 316, the one or the aircraft data can be installed onto the one or more aerospace systems 304, 308, 312, re-broadcast across the network 300, or discarded as will be discussed below in greater detail. In this way, the blockchain 316 can provide an extra layer of security for the aircraft data and facilitate direct communication between the members of the network 300, thus simplifying flow of the aircraft data through the network 300. Put another way, the blockchain 316 allows each of the aerospace systems 304, 308, 312 and the ground system 320 to be nodes in the network 300, meaning that each member of the network 300 can transmit and receive aircraft data directly to other members of the network 300 without the need for centralized signal transmission point as discussed above.

As discussed above, an aerospace system can be any of a variety of systems that are used onboard an aircraft, by an airline, or by a ground control operation (e.g., the ground system 320). In particular, an aerospace system can be any system that is used to within the aerospace environment and/or to acquire and/or share data (e.g., aircraft data) between aircraft, maintenance crews, air traffic controllers, pilots, and passengers during operation of an aircraft as discussed above. An aerospace system can be any combination of software and hardware within this context. In some aspects, the aerospace systems 304, 308, 312 can include hardware and software that are used to ensure that the aerospace systems 304, 308, 312 are in compliance with the latest safety guidelines and have access to the latest data available when making flight decisions. For example, the aerospace systems 304, 308, 312 can be connected to one another via the blockchain 316 without the use of an intermediary ground communications system, thus simplifying A2A communication of aircraft data.

In some aspects, the aircraft data can originate from any member in the network 300 and can include identification information therein such as a unique hash ID as will be discussed below in greater detail. After the aircraft data is created or identified by a particular aerospace system (e.g., the first aerospace system 304), the aerospace system can store or archive the aircraft data in a data repository. The aerospace system may be able to access the aircraft data after it has been archived in the data repository by interfacing with the blockchain 316, or the aerospace can interface directly with the data repository. To interface with the blockchain 316, the aerospace system can include a communications module, as will be discussed below in greater detail.

In some aspects, a data repository can be configured to store any suitable type of data or data related to software. A data repository can be arranged as a dedicated storage system, such as a dedicated cloud network system or a dedicated software server. However, it is contemplated that a data repository may also be arranged as a decentralized storage system and can itself be stored on a blockchain. For example, a data repository can be an electronic flight bag, a flight server, or another dedicated system that is included within an aerospace system. Additionally, a data repository can include information organized using any of a variety of suitable technique or combination of techniques. For example, a data repository can be organized as a relational database, or a non-relational database. In some aspects, a data repository a can receive identifying information (e.g., package data) associated with aircraft data and can store the identifying information in connection with metadata related to the aircraft data. For example, and as described below in greater detail, aircraft data can be associated with a unique hash ID encoded with identifying information (e.g., timestamp, source location, current storage location, etc.), and a blockchain can be used to securely transmit the unique hash ID to the data repository and archive the unique hash ID and the aircraft data.

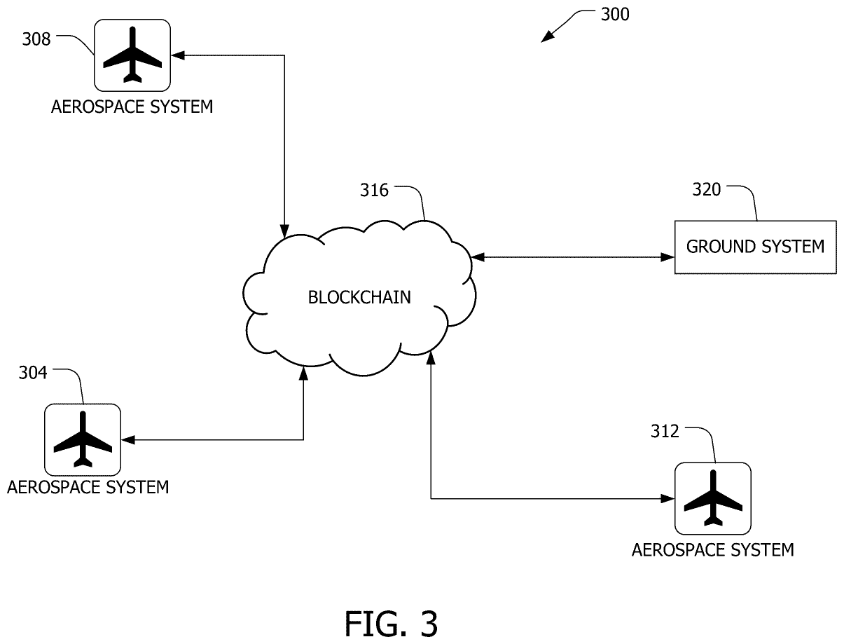

Still referring to FIG. 3, and as an example, a data repository (not shown) can store information and metadata related to the aircraft data that is broadcast by the first aerospace system 304 and received by one or more of the second aerospace system 308, the third aerospace system 312, and the ground system 320. This information and/or metadata may be configured as transaction data and can updated at each instance in which the aircraft data is broadcast or received. Accordingly, a detailed transaction history of the aircraft data can be recorded on the blockchain 316 (i.e., in the data repository (not shown)), which is accessible by any member of the network 300.

In some aspects, transactional data related to aircraft data can include information associated with modification or alteration of the aircraft data which may be indicative of malicious interference. In this way, the status of the aircraft data can be tracked as the aircraft data is accessed by different members of the network 300. Further, it is contemplated that situational-dependent data (e.g., weather data, turbulence data, traffic data, etc.) can be updated as it is received and re-broadcast by aerospace systems in a communication network, thereby ensuring that only the most relevant and accurate aircraft data is broadcast across the network. In some aspects, a data repository can be arranged as a dedicated storage system, such as cloud storage system or a dedicated server. However, it is also contemplated that a data repository can be incorporated within the blockchain 316, meaning that all data stored in a data repository can also be reflected on the blockchain 316.

A blockchain (e.g., the blockchain 316) can be used to archive and update aircraft data or identification information thereof in an encrypted and distributed record. A blockchain can be a public blockchain technology, although it is contemplated that a blockchain can alternatively be a private blockchain technology that is used by a large entity such as an airline industry or state military. In any arrangement, a blockchain can be used to structure data (e.g., software data, transactional data, etc.) into chunks that are chained together, with each block being given an exact timestamp when added to the chain. It is contemplated that any of a variety of data may be suitable for storage or use on a blockchain, such as information related to price, date, location, quality, certification, transactions, metadata, and other relevant information. Advantageously, a blockchain can include a distributed record of transactions related to aircraft data, which can be maintained across various aerospace systems in an aerospace communication network. For example, the blockchain 316 can be connected or coupled to the aerospace systems 304, 308, 312, and the ground system 320. In this way, the aerospace systems 304, 308, 312, and the ground system 320 each define nodes of the blockchain 316. Put another way, copies of the blockchain 316 can be included on each node so that a record of the transactions related to the aircraft data are stored on or are accessible by each of the aerospace systems 304, 308, 312, and the ground system 320. In some aspects, and as discussed above, the blockchain can also define a data repository, meaning that aircraft data and metadata related thereto can be stored on the blockchain.

It will be apparent to one of skill in the art that the above description is an example of a communication network an aerospace system, and that a communication may contain additional or fewer members than those described above.

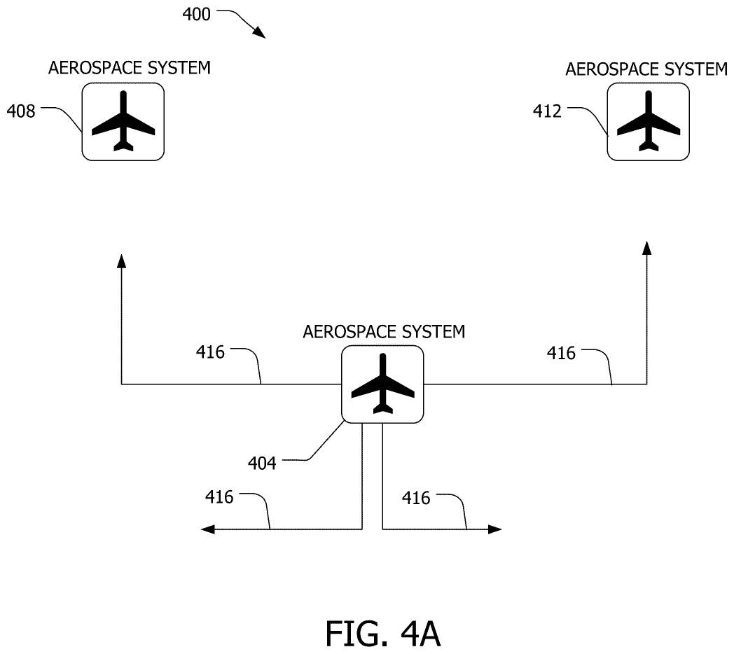

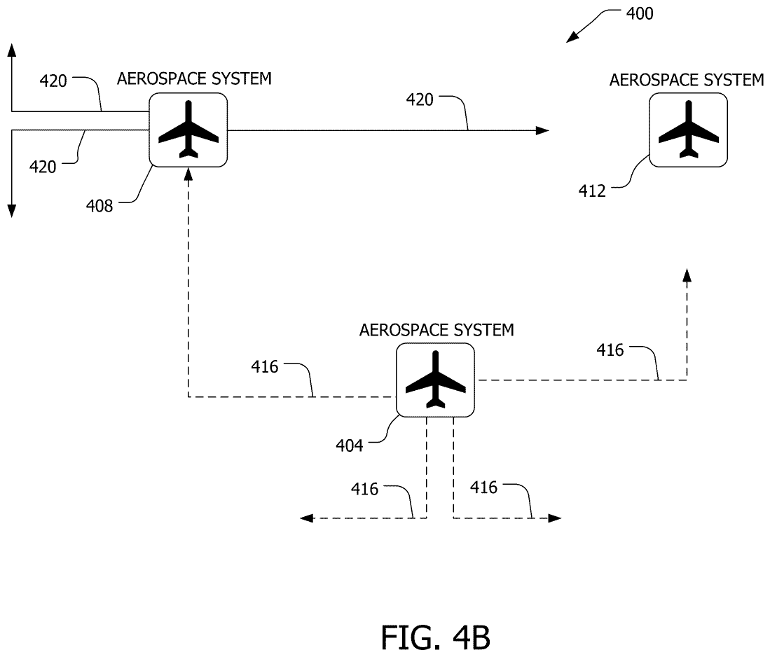

Referring now to FIGS. 4A and 4B, examples are illustrated of decentralized A2A communication networks. As discussed above, aircraft data can be securely broadcast from one aerospace system to a subsequent aerospace system by using a blockchain to connect the aerospace systems without the use of a centralized communication system (e.g., ground-based antennae network). Further, an aerospace system can broadcast aircraft data to all members of a network simultaneously, or only to a subgroup of members in the network (e.g., only aircraft that are nearby to the aerospace system or that are travelling on similar flight paths). In addition, copies of the blockchain are available to all members of the network each time the blockchain is updated. This in turn provides the ability to periodically update the aircraft data that is communicated across the network, thus providing enhanced accountability and security of the aircraft data and the members of the network. In the non-limiting example illustrated in FIG. 4A, an aerospace communication network 400 can include a first aerospace system 404, a second aerospace system 408, and a third aerospace system 412, although it is contemplated that the network 400 may include additional or fewer members as discussed above. In some aspects, the aerospace systems 404, 408, 412 may each be onboard systems for separate aircraft and/or onboard systems for nearby aircraft. In addition, the aerospace systems 404, 408, 412 may be connected to one another via a blockchain (not shown). The first aerospace system 404 can broadcast an initial stream 416 of aircraft data to each of the other members in the network 400 via a blockchain (not shown), including the second and third aerospace systems 408. After the initial stream 416 of aircraft data is received by another member in the network, the aircraft data can be re-broadcast to the other members of the network to ensure until the aircraft data reaches a predetermined endpoint (e.g., a ground system) or is broadcast a predetermined maximum number of times as will be discussed in greater detail below.

For example, and as illustrated in FIG. 4A, the initial stream 416 of aircraft data can be received by the second aerospace system 408. Once the aircraft data has been validated by the second aerospace system 408 using the blockchain (not shown), the aircraft data may be accessed and installed on the second aerospace system 408, and the second aerospace system 408 can simultaneously re-broadcast the aircraft data as a subsequent stream 420 of aircraft data to the other members of the network 400. In some aspects, the first aerospace system 404 ceases broadcasting the initial stream 416 of aircraft data after the second aerospace system 408 begins broadcasting the subsequent stream 420 of aircraft data, as indicated by the dashed lines 420. In some aspects, the subsequent stream 420 of aircraft data is received by a downstream member of the network 400 (e.g., the third aerospace system 412) and the process of validating, accessing, and re-broadcasting the data is repeated. In this way, the aircraft data originating from a single aerospace system (e.g., an aircraft) can propagate through the network to reach all aerospace systems without needing to rely upon a centralized intermediary communication means, thus providing efficient communication of real-time aircraft data to aid in decision making. In some aspects, the aircraft data is updated each time it is re-broadcast so that only the most recent data is communicated to the members of the network.

The aircraft data may continue to be broadcast until it is received by predetermined endpoint in the network. A predetermined endpoint can be a particular aerospace system or ground system which, after having received the aircraft data, signals to the other members of the network to cease broadcasting the aircraft data. In this way, the network may prevent the same aircraft data from being broadcast to any one member more than once. Put another way, the use of an endpoint in the network ensures that members of the network do not receive unnecessary duplicate aircraft data. For example, a predetermined endpoint can exist as a geographical boundary, meaning that the aircraft data is prevented from being broadcast to other members of the network outside of a particular geographical area. This can be particularly advantageous in the case of weather data which may be localized to a specific geographical area. In another example, a predetermined endpoint can be a ground system such as an ATC.

In some aspects, the aerospace systems include limitation parameters which prevent aircraft data from being further re-broadcast after the aircraft data has already been re-broadcast a predetermined maximum number of times. Put another way, aerospace systems in a communication network cease broadcast of the aircraft data after it has been re-broadcast to a certain number of other members or a certain number of times. For example, a network can cease broadcasting particular aircraft data after is has been re-broadcast 5 times, 25 times, 50 times 100 times, or 500 times. However, it is contemplated that any suitable broadcast limit can be implemented. In another example, a network can cease broadcasting particular aircraft data after it is determined to have been re-broadcast to a particular subset of aerospace systems in a network. In this way, aircraft data is only re-broadcast to aerospace systems where it will be relevant. For example, aircraft data may only be broadcast using a blockchain between aerospace systems along a shared flight route or nearby flight routes. Further, limiting the amount of times an aircraft can be re-broadcast allows new aircraft data to be broadcast across the network more frequently, leading to periodical updates of specific, relevant data. As a result, aerospace systems in a decentralized communication network may have more relevant information available during decision making, thus leading to a greater degree of flight efficiency and safety. Correspondingly, it is contemplated that aircraft data can change based on aircraft state, and that particular subsets of aircraft data may not be communicated to every member in an aerospace communication network, as will be discussed below in greater detail.

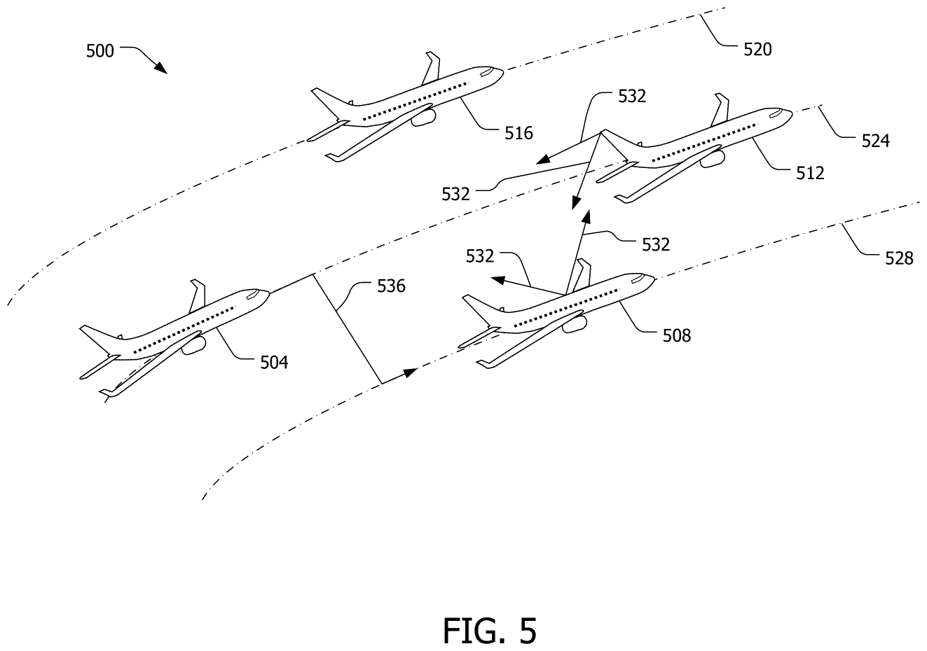

Referring now to FIG. 5, a decentralized aerospace communication network 500 can include a first aircraft 504, a second aircraft 508, a third aircraft 512, and a fourth aircraft 516. The fourth aircraft 516 can be travelling a first flight route 520, the first and third aircraft 504, 512 can be travelling along a second flight route 524, and the second aircraft 508 can be travelling along a third flight route 528. In some aspects, the aircraft 504, 508, 512, 516 can each include flight management systems (FMS) or another similar computing device which aid in making decisions related to aircraft flight route, speed, elevation, etc. In addition, the aircraft 504, 508, 512, 516 can include onboard aerospace systems that communicate with one another using a blockchain. Specifically, the aircraft 504, 508, 512, 516 are capable of identifying, transmitting, and receiving aircraft data from one another since they are part of the decentralized network 500. For example, the second and third aircraft 508, 512 may be ahead of the first aircraft 504 and may be recording flight data (e.g., weather data, wind data, turbulence data, etc.). The second and third aircraft 508, 512 can broadcast the flight conditions to each another and the first aircraft 504, as indicated by arrows 532. As a non-limiting example, the second aircraft 508 may identify favorable flight conditions (e.g., low turbulence, low wind, clear airspace, etc.) along the third flight route 528 and transmit the favorable flight conditions as aircraft data to the first aircraft 504. In addition, the third aircraft 512 may identify poor flight conditions (e.g., high turbulence, high wind, crowded airspace, etc.) along the second flight route 524 and transmit the poor flight conditions as aircraft data to the first aircraft 504. In this way, the first aircraft 504 can be provided with real-time flight condition data which can be accessed by the FMS to make an informed flight route decision. In the non-limiting example, the FMS of the first aircraft 504 may consider that the second flight route 524 is more favorable than the first flight route 520 based on the aircraft data provided by the second and third aircraft 508, 512, and the first aircraft 504 may choose to pursue the more favorable flight route (i.e., the third flight route 528) as indicated by arrow 536. Accordingly, the real-time broadcast of aircraft data between aircraft provided by the decentralized network can permit secure A2A communication and enhance aircraft safety. It will be understood that the above description is a non-limiting example, and that any type of aircraft data as discussed above for FIGS. 1A-1C can be broadcast between aircraft in any arrangement to provide relevant information and support informed decision-making, within the careful constrains that are unique to aircraft.

A member of an aerospace communication network (e.g., an aerospace system onboard an aircraft or a ground system) can include software programs or instructions that are configured to direct the functions thereof. In some aspects, a member of an aerospace communication network that is downstream of an aerospace system (e.g., a subsequent aerospace system) can define a downstream server. In some aspects, a downstream server can be in communication with a blockchain, and an aerospace can also be in communication with a blockchain. In particular, an aerospace system and a downstream server can each include hardware components that can be used to establish communication across an aerospace communication network using a blockchain. Put another way, a blockchain communication network can be established between an aerospace system and a downstream server across which aircraft data can be provided. In some non-limiting aspects, aircraft data can be a package of data related to a software update, flight data, or another type of data as discussed above for an aerospace system. It is contemplated that the aircraft data can be configured as any type of suitable data, such as cloud network data, electronic data, data stored on physical media, or another type of data as discussed below.

In some aspects, aircraft data can be communicated over any suitable aerospace communication network using a blockchain, such as a Wi-Fi network (which can include one or more wireless routers, one or more switches, and the like), a peer-to-peer network (e.g., a Bluetooth network), a cellular network (e.g., a 3G network, a 4G network, a 5G network, etc., complying with any suitable standard(s), such as CDMA, GSM, LTE, LTE Advanced, WiMAX, 5G NR, etc.), a wired network, a local area network (LAN), a wide area network (WAN), a public network (e.g., the Internet, which may be part of a WAN and/or LAN), a private or semi-private network (e.g., a corporate or university intranet), a VHF radio network, any other suitable type of network, or any suitable combination of networks.

Correspondingly, techniques used to secure aircraft data using a blockchain as discussed herein can also be compatible with any other suitable technique or combination of techniques. Specifically, aircraft data transmitted across an aerospace communication network can further be encrypted using any suitable technique or combination of techniques. For example, aircraft data can be encrypted using a blockchain technology and based on or more of Transport Layer Security (TLS) protocols, Secure Sockets Layer (SSL) protocols, or Internet Protocol Security (IPsec) protocols. As another example, a virtual private network (VPN) connection can be established between a downstream server and an aerospace system. As yet another example, a downstream server and an aerospace system can be used to limit access to an aerospace communication network, meaning that an aerospace communication network can be required to provide credentials (e.g., a username, a password, a hardware-based security token, a software-based security token, a one-time code, any other suitable credentials, or any suitable combination of credentials).

In some aspects, a downstream server and an aerospace system can each include any of a variety of suitable hardware, firmware, and/or software for communicating aircraft data over an aerospace communication network. For example, the downstream server and the aerospace system can each include one or more transceivers, one or more communication chips and/or chip sets, and the like that can be used to establish a Wi-Fi connection, a Bluetooth connection, a cellular connection, an Ethernet connection, a radio connection, and the like.

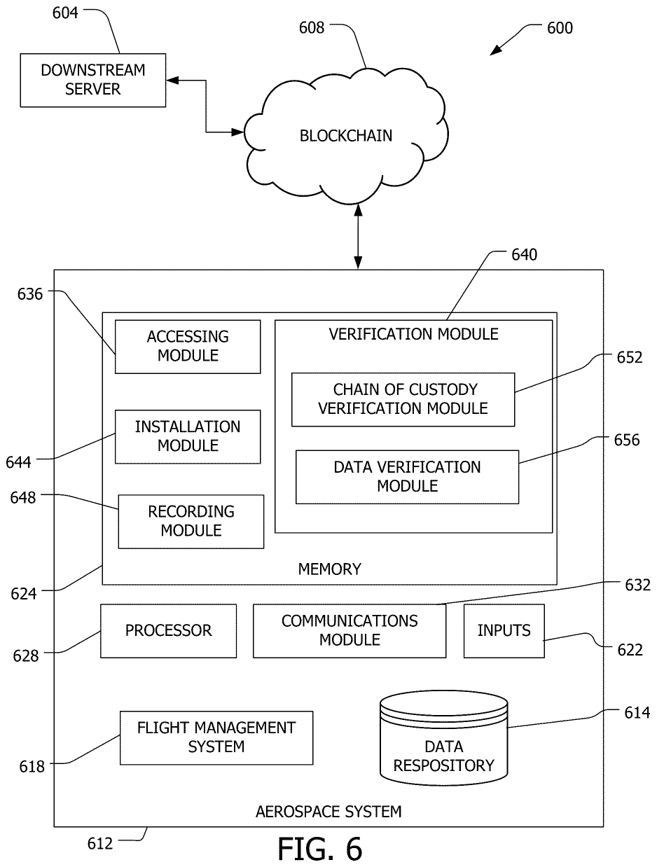

Referring now to FIG. 6, a block diagram is illustrated of an example aerospace communication network 600 that includes a downstream server 604, a blockchain 608, and an aerospace system 612. In some aspects, the downstream server 604 can be in communication with the aerospace system 612 via the blockchain 608. In some aspects, the aerospace system 612 can include a data repository 614, a flight management system (FMS) 618, one or more inputs 622, a memory 624, a processor 628, and a communications module 632. In some aspects, the FMS 618 can be configured to manage navigation, performance computations, and other aircraft operations, and the FMS 618 can be configured to run SAE AIR4653 protocols, FAA AC 25-15 protocols, SAE ARP94910 protocols, or any combination thereof. Further, the FMS 618 can be configured to periodically evaluate a status of the aerospace system 612, which can be used to select or update the type of aircraft data to be communicated across the blockchain 608, as will be discussed below in greater detail. Correspondingly, the data repository 614 can be configured to store any suitable type of data (i.e., aircraft data) and can be configured as an electronic flight bag, a flight server, or another dedicated system. In some aspects, the processor 628 can be any of a variety of suitable hardware processor or combination of processors, such as a central processing unit (CPU), a graphics processing unit (GPU), an accelerated processing unit (APU), etc. In some aspects, the inputs 622 can include any suitable input devices and/or sensors that can be used to receive user input, such as a keyboard, a mouse, a touchscreen, a graphic user interface (GUI), etc.

In some aspects, the memory 624 can include any suitable storage device or devices that can be used to store instructions, values, and the like, that can be used, for example, by the processor 628 to communicate with the downstream server 604 using the blockchain 608. Specifically, the memory can include a communications module 632 that can be executed by the processor 628 to couple (i.e., place in communication with) the aerospace system 612 to the blockchain 608 and the downstream server 604. Put another way, executing the communications module 632 facilitates decentralized communication between the aerospace system 612 and the downstream server 604 via the blockchain 608, and decentralized communication can include receiving, broadcasting, and re-broadcasting data, e.g., aircraft data. The memory 624 can include any suitable volatile memory, non-volatile memory, storage, or any suitable combination thereof. For example, the memory 624 can include RAM, ROM, EEPROM, one or more flash drives, one or more hard disks, one or more solid state drives, one or more optical drives, and the like.

In some aspects, the memory 624 can have encoded thereon one or more computer programs or modules stored in the memory 624 for controlling operation of the aerospace system 612. Specifically, the processor 628 can be configured to execute one or more modules stored in the memory 624 to access aircraft data identified or received by the aerospace system 612, such as, e.g., aircraft data that is archived on the data repository 614. Further, the processor 628 can be configured to execute one or more modules stored in the memory 624 to verify the aircraft data and install the validated aircraft data on the aerospace system 612. For example, the processor 628 can execute an accessing module 636 to access and obtain a copy of the aircraft data, a verification module 640 to verify a unique hash ID associated with the aircraft data, and an installation module 644 to install the verified aircraft data onto the aerospace system 612. Additionally, the processor 628 can execute a recording module 648 that records instances of receiving, accessing, verifying, installing, and broadcasting the aircraft data, as will be discussed below in greater detail.

In some aspects, the verification module 640 can include a chain of custody verification module 652 and a data verification module 656. The chain of custody verification module 652 can be executed by the processor 628 to verify chain of custody metadata that corresponds to the aircraft data and that can be stored on the blockchain 608 (e.g., chain of custody metadata that is associated with the unique hash ID of the aircraft data). The chain of custody metadata can include transactional data as discussed above, meaning that the chain of custody verification module 652 can determine who has accessed, archived, and broadcast the aircraft data across the aerospace communication network 600 before being accessed by the aerospace system 612. Accordingly the chain of custody verification module 652 can be used to detect if any unauthorized entities have accessed the aircraft data which may be indicative of malicious interference. Correspondingly, the data verification module 656 can be executed by the processor to verify that the data included in the aircraft data is correct, meaning that the aircraft data has not been tampered with or falsified.

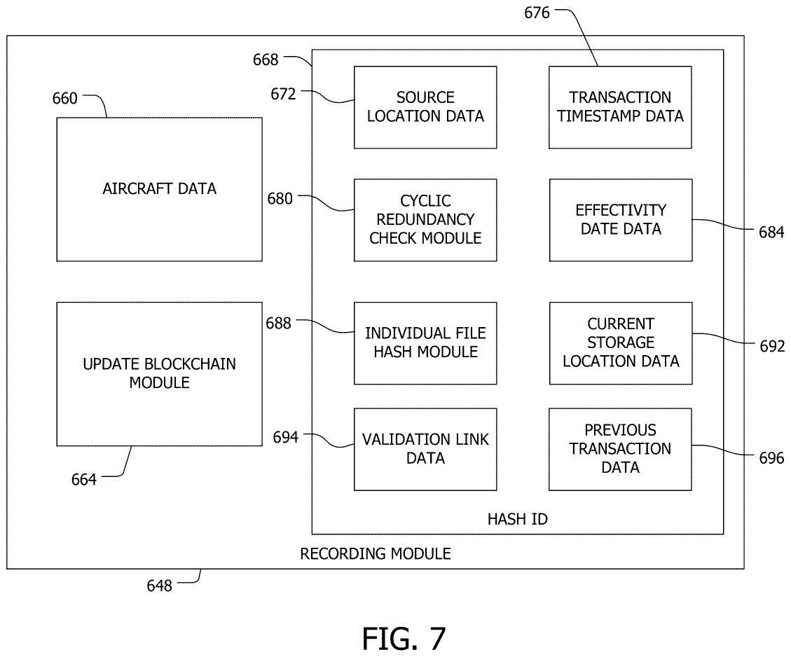

Referring now to the non-limiting example illustrated in FIG. 7, the recording module 648 can include information about data included in the aircraft data (e.g., identifying information and metadata) and a software application or module that updates the blockchain when executed. For example, the recording module 648 can include at least aircraft data 660, an update blockchain module 664, and a hash ID 668. In some aspects, the aircraft data 660 can be detected directly by the aerospace system 612 (see FIG. 6), or the aircraft data 660 can be received by the downstream server 604 (see FIG. 6) (e.g., a subsequent aerospace system). As discussed above, a hash ID can be a sequence of alphanumeric characters that is unique to the aircraft data and can be updated to record each transaction. Put another way, a unique hash ID can be modified each time aircraft data is accessed, archived, installed, and/or broadcast. In this way, it can be possible to determine when the aircraft data was last modified. Additionally, a unique hash ID can further include several different programs, modules, and/or categories of data associated with the aircraft data or transactions involving the aircraft data.

For example, the hash ID 668 can include at least source location data 672, transaction timestamp data 676, a cyclic redundancy check module 680, effectivity date data 684, an individual file hash module 688, current storage location data 692, a validation link 694, and previous transaction data 696. The source location data 672 can provide identify a source from which the aircraft data originated (i.e., a member in the network 600 (see FIG. 6) who first broadcast the aircraft data). The transaction timestamp data 676 can identify a date, time, and/or location from which the secure aircraft data is accessed, archived, installed, and/or broadcast. When executed by the processor 628 (see FIG. 6), the cyclic redundancy check module 680 can be configured to detect accidental or unexpected errors in the aircraft data 660 to ensure that the integrity of the aircraft data 660 has not been compromised. The effectivity date data 684 can identify a date or date range in which the aircraft data can be accessed by a user. In some aspects, effectivity dates can be different for different members in an aerospace communication network. When executed by the processor 628 (see FIG. 6), the individual file hash module 688 can be configured to provide a unique hash ID to each file included in the aircraft data which in turn can further enhance security of the aircraft data 660. The current storage location data 692 can provide information on the current storage location of the aircraft data, such as a location on the blockchain 608, on the aerospace system 612 (e.g., an aircraft ID on the aerospace system 612) (see FIG. 6), or in the data repository 614. The validation link 694 can be a link to the validation of the hash ID 668 of the aircraft data on the blockchain 608 (see FIG. 6). Put another way, the validation link 694 can be a link to a block on the blockchain 608 (see FIG. 6) in which the aircraft data was validated. In some aspects, the previous transaction data 696 can identify the most recent transaction associated with the aircraft data or the comprehensive transactional history thereof. In this way, each transaction along an aerospace communication network involving the aircraft data can be recorded.

The update blockchain module 664 can be executed by the processor 628 (see FIG. 6) to create a new block that can be added or linked to a blockchain. In some aspects, the update blockchain module 664 can be executed by the processor 628 without any user interaction since a blockchain can be a decentralized network, meaning that each member of an aerospace communication network can frequently broadcast and record transactions. A new block can include any identifying information as described above, such as the different modules and data categories included in the hash ID 668 and the aircraft data 660. In this way, a blockchain can be updated to include a new block identifying that a new transaction has occurred, and the new block can include identifying information or metadata associated with the new transaction. As discussed above, the new block can be distributed to each member along an aerospace communication network such that copies of the transaction can be available to any member of the aerospace communication network, thus enhancing transaction clarity through the network which in turn can increase the security of the aircraft data. However, it is contemplated that specific transactions may only be available to particular members along the aerospace communication network for privacy or efficiency reasons as discussed above.

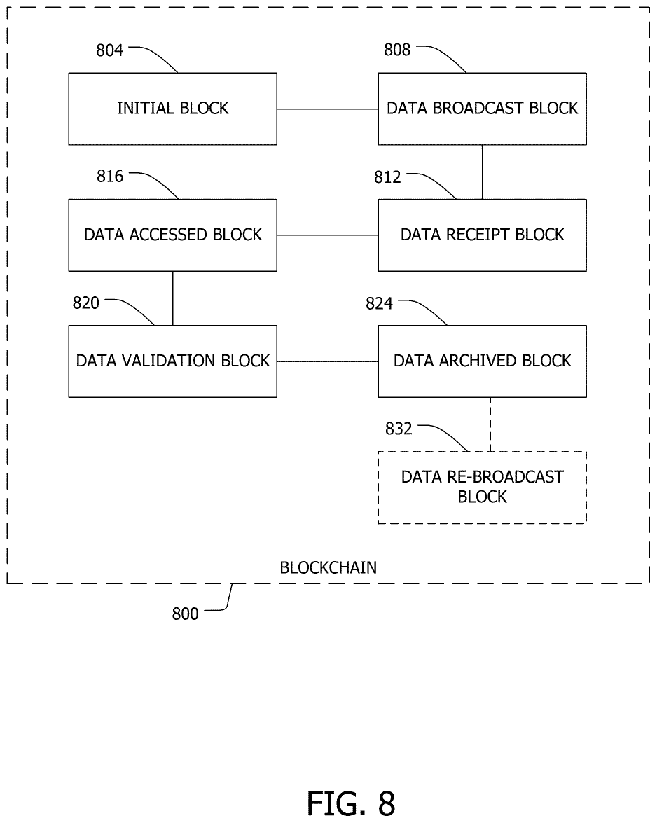

Correspondingly, and as discussed above, a blockchain can include any number of blocks that are linked to one another. In particular, a blockchain can include blocks that identify transactions associated with aircraft data being accessed, archived, installed, and/or broadcast by different members of the aerospace communication network. It is contemplated the blockchain can be arranged in any suitable configuration for recording transactional information and optionally storing aircraft data thereon. In the non-limiting example illustrated in FIG. 8, a blockchain 800 can include several different blocks detailing a transactional history of aircraft data as it is provided along an aerospace communication network. Specifically, the blockchain 800 can include an initial block 804 that can may be created when aircraft data is initially created or identified by a member in an aerospace communication network. A data broadcast block 808 can be created at each instance in which aircraft data is broadcast or sent from one member of network to another. Relatedly, a data receipt block 812 can be created at each instance in which aircraft data is received by a member of the network. A data accessed block 816 can be created at each instance in which aircraft data is accessed by a member of the network using a blockchain. A data validation block 820 can be created at each instance in which aircraft data is validated or verified by a member of the network using the secure protocols as discussed above. A data archived block 824 can be created at each instance in which aircraft data is archived or stored, such as instances in which the aircraft data is archived on a data repository or on the blockchain 800. A data re-broadcast block 832 can optionally be created if aircraft data is re-broadcast from an aerospace system after having been accessed and validated thereby. Put another way, the data re-broadcast block 832 can be created at each instance in which aircraft data is re-broadcast or further communicated across the network. It is contemplated that a blockchain can include additional or fewer blocks than those described above, and that any number of copies of any block can be stored on a blockchain. Further, it is contemplated that the blocks and transactions described above may be associated with any member of an aerospace communication network, such as one or more aerospace systems onboard aircraft or included in ground systems, such as, e.g., ATC systems.

There are several advantages of coupling an aerospace system to a blockchain in an aerospace communication network. In particular, and as discussed above, using a blockchain to archive and access aircraft data for an aerospace system provides a decentralized transaction record to each member of an aerospace communication network which in turn improves privacy while enhancing security throughout the network. The decentralized transaction record can be used by aerospace systems to ensure that aircraft data has not been maliciously interfered with or falsified during broadcast across the network, thereby maintaining the integrity of the aircraft data along the network. Thus, by validating aircraft data throughout an aerospace communication network using a decentralized blockchain framework, only secure aircraft data can be selected for installation on an aerospace system and further broadcast across the aerospace communication network. Further, using a decentralized blockchain to communicate aircraft data across a network eliminates the need for reliance upon the cost-intensive barriers to entry associated with conventional centralized communication systems, as discussed above. In this way, A2A communication may be capable of being scaled globally to facilitate the broadcasting of real-time, relevant data across an aerospace communication network. Accordingly, the safety of pilots, passengers, ground crew, and other personnel associated with aerospace systems can be improved, and the overall efficiency of aerospace travel can be improved.

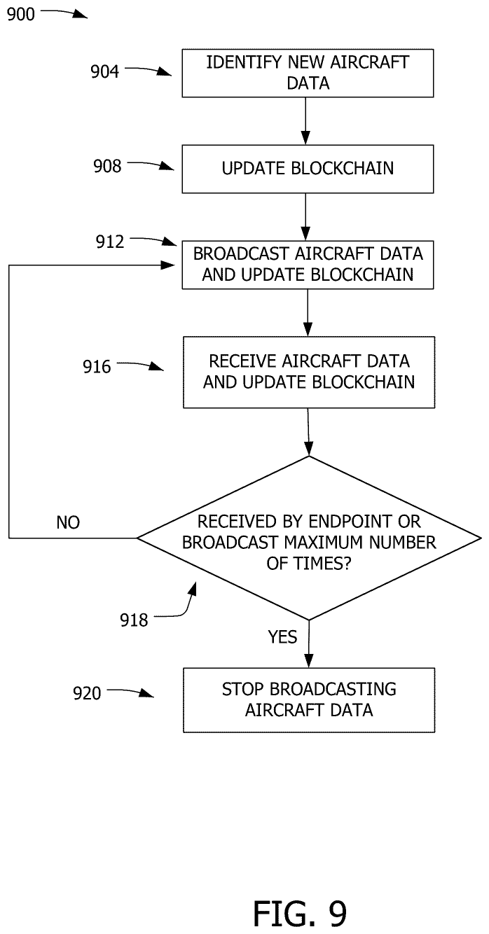

FIG. 9 illustrates a non-limiting example of a process for providing aircraft data across an aerospace communication network using a blockchain in accordance with some aspects of the present disclosure. Specifically, the process 900 can be used to identify, receive, and/or broadcast aircraft data. The process can include identifying a new aircraft data (e.g., a secure aircraft data) at step 904 and updating the blockchain at step 908 with a new block to record and identify the new aircraft data. At 912, the process 900 can include transmitting or broadcasting the aircraft data to a member of an aerospace communication network. Correspondingly, the process 900 can include receiving the aircraft data and updating the blockchain to confirm receipt of the aircraft data at step 916.

In some aspects, the process 900 can include determining if the aircraft data has been received by an endpoint along the network or broadcast a maximum number of times at step 918. If the aircraft data has not been received by an endpoint and has not yet been broadcast a maximum number of times, the process 900 can repeat steps 912 and 916 of broadcasting and receiving the aircraft data, respectively, until the either the aircraft data has been received by an endpoint or broadcast a maximum number of times. For example, aircraft data may continue to be broadcast or re-broadcast across an aerospace communication network until the aircraft data is received by a ground-based ATC system (i.e., an endpoint). As another example, aircraft data, may be re-broadcast across an aerospace communication network until the number of times the aircraft data has been broadcast reaches a predetermined threshold value, such as, e.g., 5 times, 25 times, 50 times, 100 times, or 500 times as discussed above. In this way, the process 900can include ceasing to broadcast the aircraft data once a predetermined endpoint or a maximum number of broadcast times has been reached at step 920. Thus, it can be necessary to repeat steps 912 and 916 of broadcasting and receiving the aircraft data to ensure that the aircraft data is broadcast to the correct members of the aerospace communication network. Accordingly, multiple receipts of the aircraft data corresponding to different members of the aerospace communication network can be confirmed using the blockchain (e.g., a first receipt, a second receipt, a third receipt etc.) Alternatively, and as discussed above, the process 900 can include archiving the aircraft data in a data repository at where it can be accessible by one or more members of the aerospace communication network. In this way, it may not be necessary to directly broadcast the aircraft data between members in the aerospace communication network. Rather, aircraft data can be archived in a data repository using a blockchain to distribute copies of the aircraft data to each member, and the blockchain can also distribute copies of any updates or modifications made to the aircraft data to each member in the aerospace communication network. It is contemplated that a blockchain can be updated to record any of the above steps or transactions to provide a comprehensive transaction record associated with the aircraft data along the aerospace communication network.

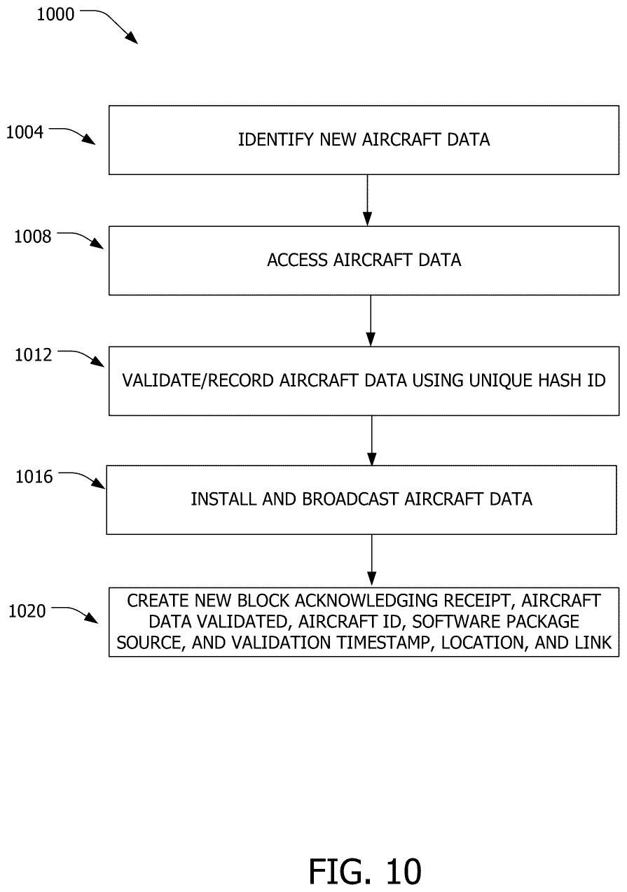

FIG. 10 illustrates a non-limiting example of a process for receiving aircraft data over a decentralized aerospace communication network, in accordance with some aspects of the present disclosure. In particular, a process 1000 can include identifying aircraft data (e.g., newly recorded aircraft data or a copy of aircraft data distributed by a blockchain) at step 1004 by an aerospace system. At step 1008, the process 1000 can include accessing the aircraft data, including accessing aircraft data stored on a data repository or a blockchain as discussed above. Further, the aerospace system can access the aircraft data using any suitable technique, such as retrieving a block in a blockchain that is associated with aircraft data that is stored on a data repository. At step 1012, the process 1000 can include validating the aircraft data and the related chain of custody data using a unique hash ID associated with the aircraft data. As discussed above, the unique hash ID can include a variety of identifying information or metadata associated with the aircraft data, including a chain of custody or transactional record. By validating the chain of custody, the aerospace system can ensure that the aircraft data being accessed has not been maliciously interfered with or falsified by an unauthorized party. After the aircraft data has been validated, the process 1000 can include loading or installing the aircraft data onto an aerospace system and simultaneously broadcasting a copy of the aircraft data to one or more subsequent aerospace systems (i.e., other members in the aerospace communication network) at step 1016. Accordingly, only aircraft data that have been validated are installed onto the aerospace system and broadcast across the network, thus preventing compromised data from being communicated and installed across the network. For example, a copy of the validated aircraft data can be stored on the blockchain, meaning that a copy of the validated aircraft data can be made available to each member of the decentralized network via the blockchain. In some aspects, the process 1000 can include creating a new block for updating the blockchain at step 1020 to acknowledge that the aircraft data has been securely accessed, validated, and installed, and broadcast by the aerospace system. As discussed above, the new block can include identification information or metadata related to the aircraft data, and copies of this information can be distributed to all members in the decentralized aerospace communication network via the blockchain.

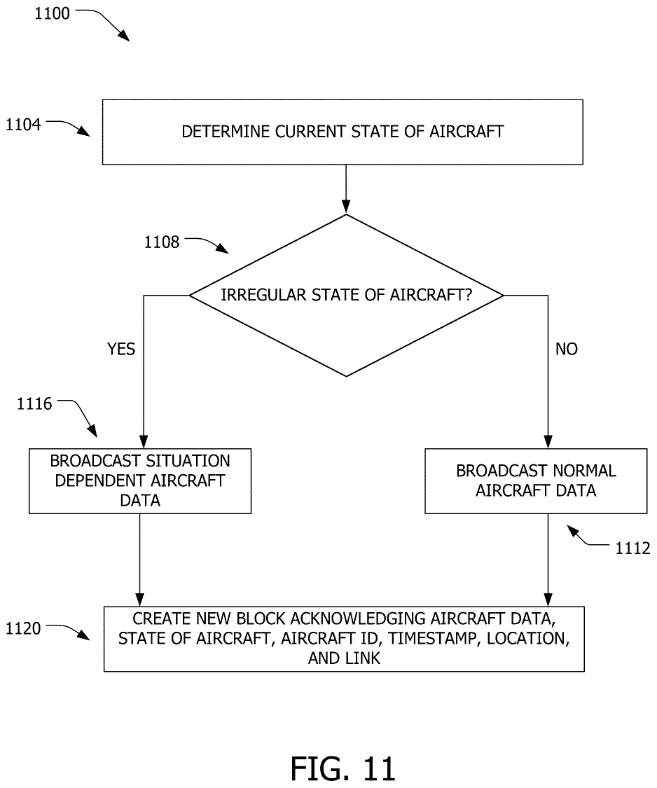

FIG. 11 illustrates a method of selecting or updating aircraft data to be communicated over a decentralized aerospace communication network based on a state of an aircraft, according to some aspects of the present disclosure. As discussed above, an aerospace system onboard an aircraft can select or update a particular or additional subsets of aircraft data to broadcast over a decentralized aerospace communication network based upon a state of the aircraft. In some aspects, a state of an aircraft can be determined by periodically running diagnostic checks on the aerospace system, or an aircraft state can be updated manually (e.g., input by a pilot or crew member). In some aspects, a process 1100 of updating aircraft data based on aircraft state can include first determining a current state of the aircraft at step 1104. For example, an aircraft can have a normal state to indicate normal flight and operational conditions, and an irregular state to indicate irregular flight or operational conditions.

However, it is contemplated that additional aircraft states may also exist, such as, e.g., aircraft states associated with a particular phase of flight, particular elevation conditions, or other situational-dependent factors. In some aspects, an irregular state may correspond to a particular squawk code as input to an aircraft transponder by a user (e.g., a pilot, a crew member, and/or a passenger). For example, an aircraft can be in an irregular state if a squawk code is set to 7500 (i.e., aircraft hijacking), 7600 (i.e., aircraft with radio failure), 7700 (i.e., aircraft in emergency state), or another irregular squawk code. As another example, an irregular state may correspond to flight conditions, such as aircraft descent rate, aircraft ascent rate, elevation, speed, deviation from approved flight route, or another condition. For example, an aircraft may exist in an irregular state if the aircraft's descent rate exceeds about 5,000 feet per minute.

At step 1108, the process 1000 can include determining if the current state of the aircraft is in an irregular state. If the current state of the aircraft is the normal state, the process 1000 can include broadcasting normal aircraft data (i.e., aircraft data as discussed above) at step 1112. However, upon determining that the current aircraft state is the irregular state, the process 1000 can include updating the aircraft data to include situational dependent data and broadcasting the updated aircraft data at step 1116. In some aspects, situational dependent data can include aircraft state data, flight data recorder (FDR) data, cockpit voice recorder (CVR) data, positional data, or another type of aircraft data as discussed above for FIGS. 1A-1C. In some aspects, the process 1000 can include creating a new block for updating the blockchain at step 1120 to acknowledge that the aircraft status has been determined and that the aircraft data has been updated accordingly. In addition, the blockchain can be updated to acknowledge that the aircraft data has been broadcast by the aerospace system onboard the aircraft. As discussed above, the new block can include identification information or metadata related to the aircraft data and the aircraft status, and copies of this information can be distributed to all members in the decentralized aerospace communication network via the blockchain.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

As used in the claims, the phrase “at least one of A, B, and C” means at least one of A, at least one of B, and/or at least one of C, or any one of A, B, or C or combination of A, B, or C. A, B, and C are elements of a list, and A, B, and C may be anything contained in the Specification.

1. A communication system for an aerospace system, the communication system comprising:
a communications module configured to communicatively couple the aerospace system to an aircraft communication network using a blockchain; and
a processor configured to communicate aircraft data having a unique hash ID between the aerospace system and one or more subsequent aerospace systems in the aircraft communication network via the communications module by:
accessing or receiving the aircraft data,
validating the unique hash ID of the aircraft data using the blockchain, and
only upon validation of the unique hash ID, installing the aircraft data on the aerospace system and broadcasting a copy of the aircraft data to the one or more subsequent aerospace systems.

2. The communications system of claim 1, wherein the unique hash ID of the aircraft data includes:
a cyclic redundancy check for each file in the aircraft data;
a unique secondary hash ID for each file in the aircraft data;
effectivity dates for the aircraft data; or
a current storage location of the aircraft data.

3. The communications system of claim 1, wherein the communications system creates a new block when using the blockchain, and wherein the new block includes identification information for:
the aircraft data that was accessed and validated;
a source from which the aircraft data originated;
a date, a time, or a location from which the aircraft data is accessed and validated;
a link to the validation of the unique hash ID of the aircraft data on the blockchain; or
a current storage location of the aircraft data.

4. The communications system of claim 1, wherein the communications module is further configured to:
determine if the aircraft data has been broadcasted a predetermined maximum number of times or has been received by a predetermined endpoint in the aircraft communication network;
upon determining that the aircraft data has not been broadcasted the predetermined maximum number of times and has not been received by the predetermined endpoint, continue broadcasting the aircraft data to the one or more subsequent aerospace systems; and
upon determining that the aircraft data has been broadcasted the predetermined maximum number of times or has been received by the predetermined endpoint, cease broadcasting the aircraft data.

5. The communications system of claim 1, wherein the aircraft data includes at least one of weather data, turbulence data, air traffic control data, and automatic dependent surveillance-broadcast data.

6. The communications system of claim 1, wherein the processor is further configured to:
determine if a current state of the aerospace system is a normal state or an irregular state; and
upon determining that the current state is the irregular state, update the aircraft data to include situational dependent data including at least one of aircraft state data, flight data, recorder data, cockpit voice recorder data, or positional data.

7. The communications system of claim 1, wherein the aerospace systems and the one or more subsequent aerospace systems are aircraft systems, ground systems, or a combination thereof.

8. The communications system of claim 1, wherein the communications system includes software applications that, when executed, perform the operations of:
creating a block in the blockchain;
accessing and validating the aircraft data;
installing the aircraft data on the aerospace system; and
broadcasting the copy of the aircraft data to the one or more subsequent aerospace systems.

9. A method of communicating aircraft data between an aerospace system and one or more subsequent aerospace systems, the method comprising:
identifying the aircraft data having a unique hash ID;
coupling a communications system to the aerospace system to receive the aircraft data;
validating the unique hash ID for the aircraft data using a blockchain; and
upon validation of the unique hash ID, installing the aircraft data on the aerospace system and broadcasting a copy of the aircraft data to the one or more subsequent aerospace systems using the communications system.

10. The method of claim 9, wherein the unique hash ID for the aircraft data is created by:
creating a cyclic redundancy check for each file in the aircraft data;
creating a unique secondary hash ID for each file in the aircraft data;
creating effectivity dates for the aircraft data; and
updating a current storage location of the aircraft data.

11. The method of claim 9, wherein using the blockchain comprises creating a new block that includes identification information for:
the aircraft data that is accessed and validated;
a source from which the aircraft data originated;
a date, a time, or a location from which the aircraft data is accessed and validated;
a link to the validation of the unique hash ID for the aircraft data on the blockchain; or
a current storage location of the aircraft data.

12. The method of claim 9, the method further comprising:
determining if the aircraft data has been received by a predetermined endpoint or has been broadcasted a predetermined maximum number of times;
upon determining that the aircraft data has not been received by the predetermined endpoint and has not been broadcasted the predetermined maximum number of times and, continue broadcasting the aircraft data to the one or more subsequent aerospace systems; and
upon determining that the aircraft data has been received by the predetermined endpoint or has been broadcasted the predetermined maximum number of times, ceasing to broadcast the aircraft data.

13. The method of claim 12, wherein the aircraft data includes at least one of weather data, turbulence data, air traffic control data, and automatic dependent surveillance-broadcast data.

14. The method of claim 13, wherein the aerospace systems and the one or more subsequent aerospace systems are aircraft systems, ground systems, or a combination thereof.

15. The method of claim 9, wherein validating the unique hash ID for the aircraft data is performed by the communications system and includes validating a chain of custody of the aircraft data using the blockchain and the communications system.

16. The method of claim 9, wherein the aerospace system includes a dataloading system.

17. The method of claim 9, the method further comprising:
determining if a current state of the aerospace system is a normal state or an irregular state; and
upon determining that the current state is the irregular state, update the aircraft data to include situational dependent data including at least one of aircraft state data, flight data recorder data, cockpit voice recorder data, or positional data.

18. The method of claim 9, wherein the communications system includes software applications that, when executed, perform the operations of:
creating an initial block in the blockchain;
accessing and validating the aircraft data;
installing the aircraft data on the aerospace system; and
broadcasting the copy of the aircraft data to the one or more subsequent aerospace systems.

19. A non-transitory computer-readable medium containing software applications that, when executed, cause a communications system to perform the operations of:
accessing or receiving aircraft data to provide a copy of the aircraft data to an aerospace system;
validating a unique hash ID for the aircraft data using a blockchain; and
upon validation of the unique hash ID, installing the aircraft data on the aerospace system and broadcasting the copy of the aircraft data to one or more subsequent aerospace systems.

20. The non-transitory computer-readable medium of claim 19, wherein using the blockchain comprises creating a new block that includes identification information for:
the aircraft data that is accessed and validated;
a source from which the aircraft data originated;
a date, a time, or a location from which the aircraft data was accessed and validated;
a link to the validation of the unique hash ID for the aircraft data on the blockchain; or
a current storage location of the aircraft data.
